(19) United States
(12) Patent Application Publication
(10) Pub. No.: US 2015/0331640 A1
(43) Pub. Date: Nov. 19, 2015

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Masanori Matsuzaki, Kawasaki-shi (JP)

(21) Appl. No.: 14/710,225

(22) Filed: May 12, 2015

(30) Foreign Application Priority Data
May 14, 2014 (JP) 2014-100843

(51) Int. Cl. G06F 3/12; G06K 15/02

(52) U.S. Cl. CPC G06F 3/121; G06K 15/027; G06K 15/1822; G06F 3/122; G06F 3/1276; G06F 3/1234

(57) ABSTRACT

An image processing apparatus includes an image forming unit configured to form an image, an input unit configured to input, in response to detecting an abnormality in the formed image, a plurality of pieces of information about a feature of the formed image via an operation unit, and a chart forming unit configured to form, by the image forming unit, a chart for determining an abnormality in an image, wherein the chart is decided according to a combination of the plurality of pieces of information input by the input unit via the operation unit.

### BACKGROUND OF THE INVENTION

1. Field of the Invention

The present invention relates to an image processing apparatus for determining whether a printer has a defect when a user points out a defect in image quality, an image processing method, and a storage medium storing a program for executing image processing.

2. Description of the Related Art

In recent years, as the performance of electrophotographic apparatuses has been improved, there have been appeared machines (image processing apparatuses such as printers) that realize the same level of image quality as those of printing machines. It is essential to maintain high image quality in order to operate the machines in a similar way to the printing machine. However, if a printer is overused under stress for a long time, the printer is deteriorated to possibly cause abnormalities in image quality. It is difficult to automatically detect “abnormal images” caused by such deterioration or the like, by using a sensor or the like. Therefore, in many cases, the problems are handled after the users point them out. Abnormal images, however, are difficult to describe verbally. For example, in a case where a user explains that an image is “streaked,” a cause of the streak cannot be identified if detailed information about the streak such as color, direction, and size is unknown. Thus, when a user points out an abnormal image, a serviceman needs to visit the user to check the abnormal image. Then, the serviceman has to estimate defective units to identify related service parts, return to a service base to obtain the service parts, and then visit the user again to repair the defective units. Performing such processes incurs transportation costs of the serviceman and causes downtime because the machine cannot be used until the repair ends, which significantly decreases the user productivity.

In view of the problems, Japanese Patent No. 04687614 discusses a technique for facilitating handling of abnormal images as follows. More specifically, an image is output with a printer, and a scan image of the output image is acquired. Then, feature amounts are calculated, and defective parts are diagnosed.

According to the conventional technique, however, a chart and an analysis process to be applied differ depending on the type (streaks, unevenness, etc.) of an abnormal image to be diagnosed. Thus, a person executing image diagnosis needs to select the type of the abnormal image. This requires the person executing image diagnosis to have technical knowledge that enables quantitative determination of the image quality of the printer. However, in reality, a user/an administrator of the printer may not always be a person having technical knowledge. Thus, the conventional technique has a problem in that the person executing the image diagnosis is limited to a person having technical knowledge that enables quantitative determination of the image quality.

To overcome the problem, in the image diagnosis, all diagnosis processes may be executed at once using all charts to cover all types of abnormal images. In this case, however, unnecessary charts are also output, increasing costs. Furthermore, there is another problem in that since all analysis processes are executed, a longer processing time is required.

### SUMMARY OF THE INVENTION

According to an aspect of the present invention, an image processing apparatus includes an image forming unit configured to form an image, an input unit configured to input, in response to detecting an abnormality in the formed image, a plurality of pieces of information about a feature of the formed image via an operation unit, and a chart forming unit configured to form, by the image forming unit, a chart for determining an abnormality in an image, wherein the chart is decided according to a combination of the plurality of pieces of information input by the input unit via the operation unit.

According to an exemplary embodiment of the present invention, a chart and an analysis process are selected based on information that can be identified by the user by observing an output abnormal image. This can reduce costs and shorten the processing time. Furthermore, since an image quality problem can be determined based on information obtained from an abnormal image that is actually output, execution of image diagnosis becomes easier and the burden is reduced, as compared with the conventional techniques.

Further features of the present invention will become apparent from the following description of exemplary embodiments with reference to the attached drawings.

### BRIEF DESCRIPTION OF THE DRAWINGS

FIG. 1 is a configuration diagram of a system.

FIG. 2 illustrates a flow chart illustrating image processing.

FIG. 3 is a flow chart illustrating a process of executing image diagnosis according to a first exemplary embodiment.

FIG. 4 illustrates a correspondence table of a chart and an analysis process, and examples of charts according to the first exemplary embodiment.

FIG. 5 illustrates examples of correspondence tables of information identified from an abnormal image and a chart or an analysis processes according to the first exemplary embodiment.

FIG. 6 illustrates examples of a user interface (UI) for inputting information identified from an abnormal image and a UI for displaying an image diagnosis result according to the first exemplary embodiment.

FIG. 7 is a flow chart illustrating a process of executing image diagnosis with a changed scan setting according to a second exemplary embodiment.

FIG. 8 illustrates an example of a correspondence table of an analysis process and a scan setting according to the second exemplary embodiment.

FIG. 9 is a flow chart illustrating a process of executing a correction function after execution of image diagnosis according to a third exemplary embodiment.

FIG. 10 illustrates an example of a correspondence table of an analysis process and a correction process according to the third exemplary embodiment.

FIG. 11 illustrates examples of UIs for executing a correction function after image diagnosis according to the third exemplary embodiment.

### DESCRIPTION OF THE EMBODIMENTS

Various embodiments of the present invention will be described below with reference to the attached drawings.

The following describes exemplary embodiments of the present invention. In a first exemplary embodiment, by observing an output abnormal image, information that can be identified by the user is acquired, and a chart and an analysis process are selected. Then, an image quality problem that causes the abnormal image is determined by use of the selected chart and the selected analysis process. The following describes this method.

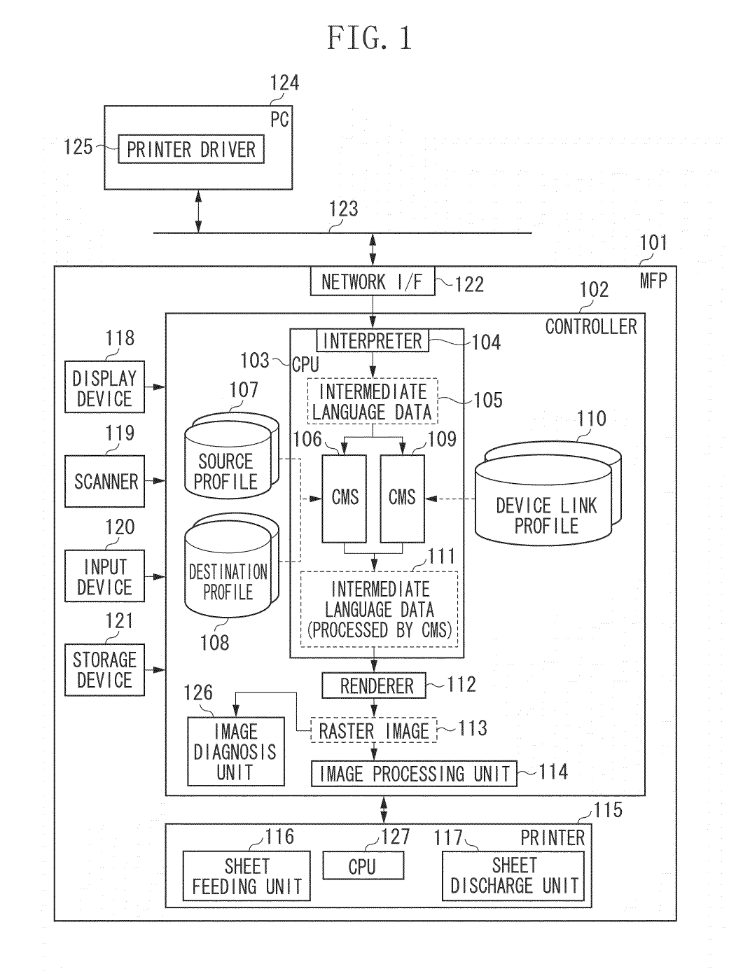

FIG. 1 is a configuration diagram of a system according to the present exemplary embodiment. A multifunction printer (MFP) 101 using cyan, magenta, yellow, and black (hereinafter, C, M, Y, and K, respectively) toners is connected to another network-compatible apparatus via a network 123. Further, a personal computer (PC) 124 is connected to the MFP 101 via the network 123. A printer driver 125 included in the PC 124 sends print data to the MFP 101.

The following describes the MFP 101 in detail. A network interface (I/F) 122 receives print data, etc. A controller 102 includes a central processing unit (CPU) 103, a renderer 112, and an image processing unit 114. An interpreter 104 of the CPU 103 interprets a page description language (PDL) part of the received print data and generates intermediate language data 105.

A color management system (CMS) 106 performs color conversion by use of a source profile 107 and a destination profile 108 to generate intermediate language data (processed by CMS) 111. The CMS performs color conversion using profile information described below. Further, the source profile 107 is a profile for converting a device-dependent color space such as a red-green-blue (RGB) color space and a CMYK color space into a device-independent color space such as an L*a*b* (hereinafter referred to as Lab) color space and an XYZ color space that are defined by the International Commission on Illumination (CIE). Similar to the Lab color space, the XYZ color space is a device-independent color space, and represents color by tristimulus values. Further, the destination profile 108 is a profile for converting a device-independent color space into a device-dependent CMYK color space (a CMYK color space dependent on a printer 115).

On the other hand, a CMS 109 performs color conversion using a device link profile 110 to generate intermediate language data (processed by CMS) 111. The device link profile 110 is a profile for directly converting a device-dependent color space such as an RGB color space and a CMYK color space into a device-dependent CMYK color space (a CMYK color space dependent on the printer 115). Which CMS is selected depends on settings in the printer driver 125.

While the present exemplary embodiment uses different CMSs (106 and 109) depending on the types of profiles (107, 108 and 110), one CMS may handle a plurality of types of profiles. Further, the types of profiles are not limited to those described as examples in the present exemplary embodiment, and any profile type may be used as long as the device-dependent CMYK color space dependent on the printer 115 is used.

The renderer 112 generates a raster image 113 from the generated intermediate language data (processed by CMS) 111. The image processing unit 114 performs image processing on the raster image 113 and an image read with a scanner 119. The image processing unit 114 will be described in detail below.

The printer 115 connected to the controller 102 is a printer configured to form output data on a sheet by use of color toners such as C, M, Y, K, etc. The printer 115 is controlled by a CPU 127 and includes a sheet feeding unit 116 and a sheet discharge unit 117. The sheet feeding unit 116 feeds sheets, and the sheet discharge unit 117 discharges sheets on which output data is formed.

A display device 118 is a user interface (UI) configured to display an instruction to the user and/or the state of the MFP 101. The display device 118 is used in an image diagnosis process described below as well as a copying process, a sending process, etc.

The scanner 119 is a scanner including an auto document feeder. The scanner 119 illuminates a bundle of document images or a sheet of a document image by use of a light source (not illustrated) and forms a reflected document image on a solid-state image sensor such as a charge coupled device (CCD) sensor by use of a lens. Then, a raster-shaped image reading signal is obtained from the solid-state image sensor as image data.

An input device 120 is an interface for receiving input from the user. A part of the input device 120 is a touch panel, so the input device 120 is integrated with the display device 118.

A storage device 121 stores data processed or received by the controller 102, etc.

When an abnormal image occurs, and is output, information that can be identified by observing the output abnormal image is input to an image diagnosis unit 126, and the image diagnosis unit 126 decides a chart and an analysis process based on the information and performs an image diagnosis process. Details of the image diagnosis process will be described below.

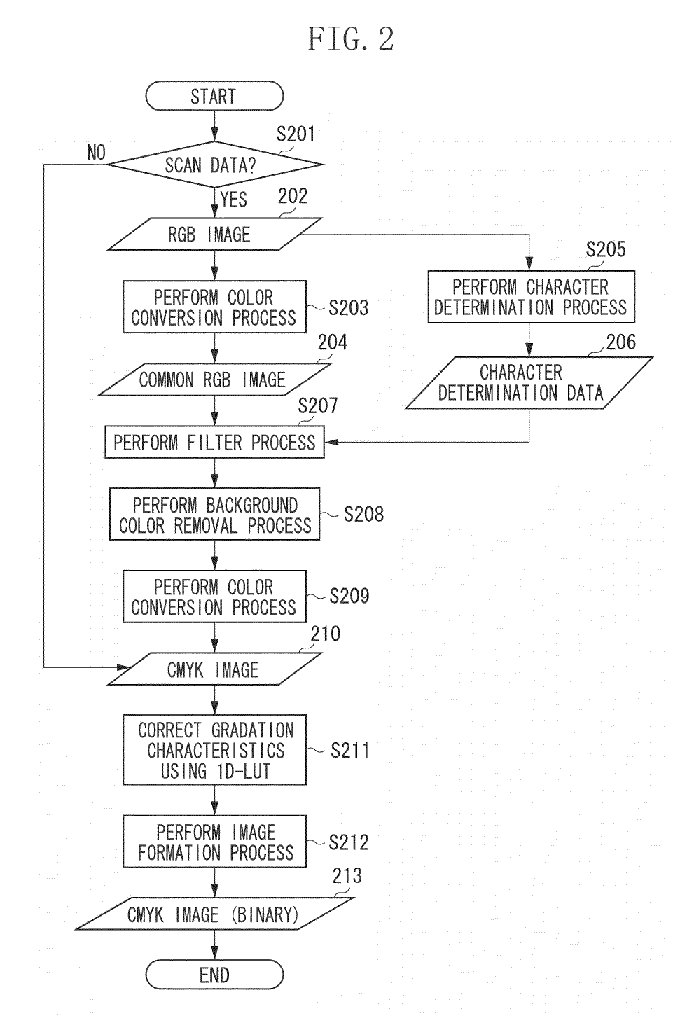

The following describes a flow of image processing performed by the image processing unit 114, with reference to FIG. 2. FIG. 2 illustrates the flow of image processing to be performed on the raster image 113 or an image read by the scanner 119. The process flow illustrated in FIG. 2 is executed and realized by an application specific integrated circuit (ASIC) (not illustrated) included in the image processing unit 114.

In step S201, whether received image data is scan data read by the scanner 119 or the raster image 113 sent from the printer driver 125 is determined.

In a case where it is determined that the received image data is not scan data (NO in step S201), the received image data is the raster image 113 bitmapped by the renderer 112. Thus, the image data undergoes the subsequent process as a CMYK image 210 converted by the CMS into a device-dependent CMYK color space dependent on the printer.

On the other hand, in a case where it is determined that the received image data is scan data (YES in step S201), the received image data is an RGB image 202. Thus, in step S203, a color conversion process is performed to generate a common RGB image 204. The common RGB image 204 is defined by a device-independent RGB color space and can be converted into a device-independent color space such as Lab by calculation.

Further, in step S205, a character determination process is performed to generate character determination data 206. At this time, edges and the like of the image are detected to generate the character determination data 206.

Next, in step S207, a filter process is performed on the common RGB image 204 by use of the character determination data 206. At this time, different filter processes are performed on character portions and other portions by use of the character determination data 206. Then, in step S208, a background color removal process is performed to remove background color components.

Next, in step S209, a color conversion process is performed to generate a CMYK image 210. Then, in step S211, gradation characteristics of the respective C, M, Y, and K colors are corrected by use of a one-dimensional look up table (1D-LUT). The 1D-LUT is a one-dimensional look up table for correcting each of the C, M, Y, and K colors.

Lastly, in step S212, the image processing unit 114 performs an image formation process such as screen processing and error diffusion processing to generate a CMYK image (binary) 213.

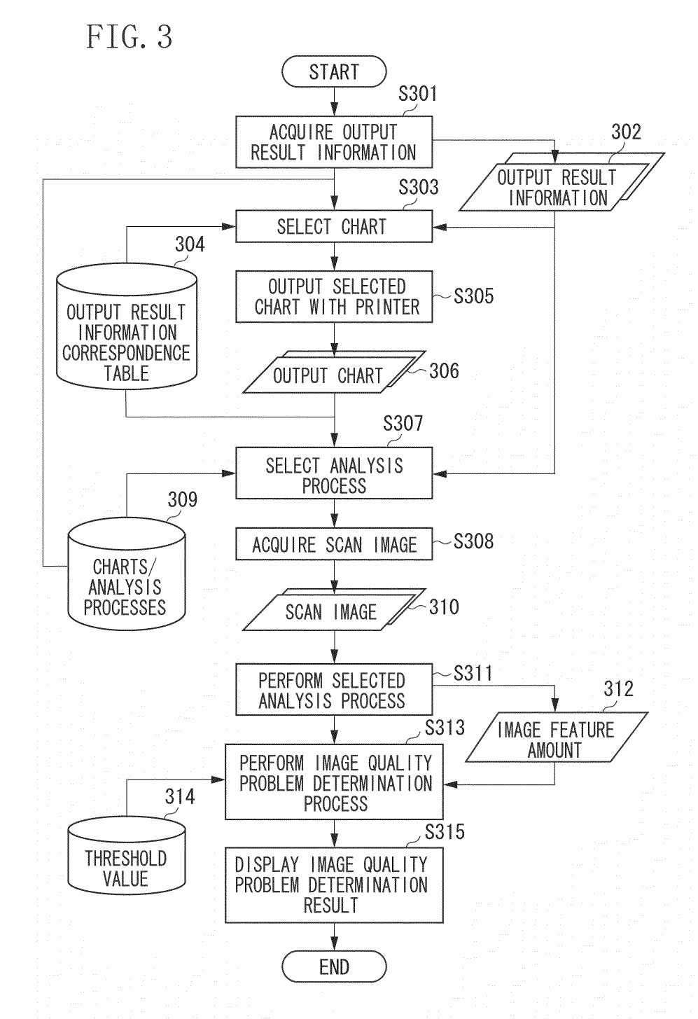

The following describes the image diagnosis process according to the present exemplary embodiment, with reference to FIG. 3. The image diagnosis process is controlled by the image diagnosis unit 126. In the process flow described below, the processes in steps S301 to S315 are executed and realized by the CPU 103 included in the controller 102, and acquired data is stored in the storage device 121. Further, the display device 118 displays an instruction to the user on a UI, and an instruction from the user is received from the input device 120.

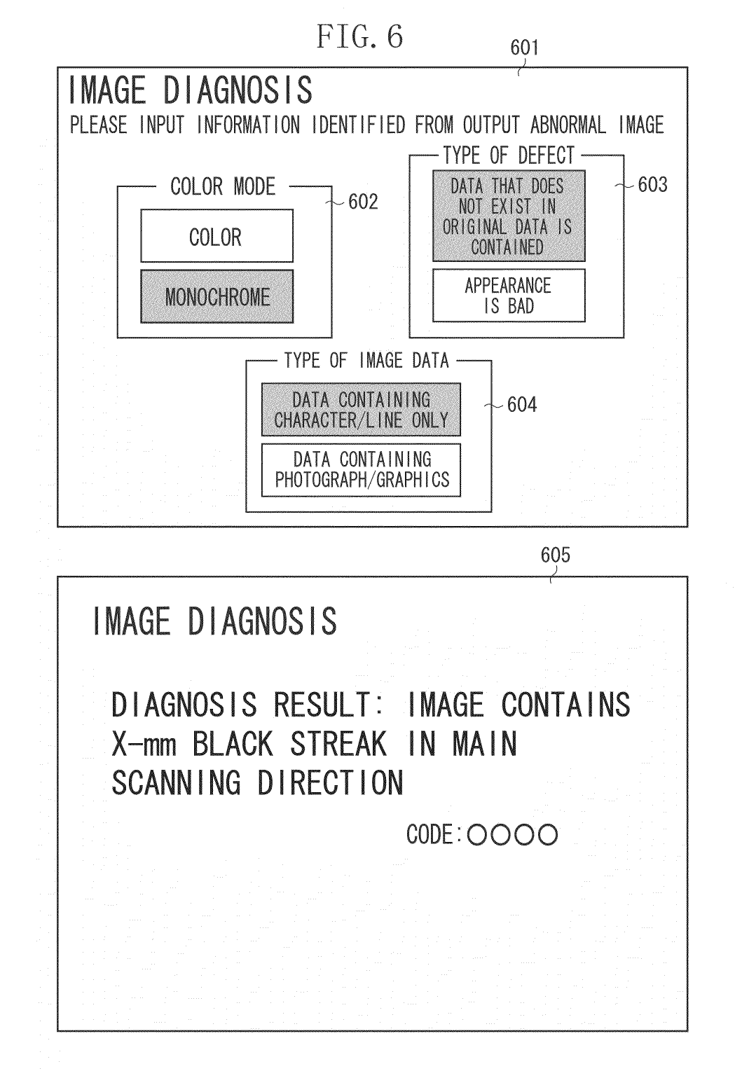

First, in step S301, output result information 302 that can be identified by observing a print output result is acquired. An example is illustrated in FIG. 6. A UI 601 is an example of a UI for inputting, when the user determines that a print output product is abnormal, information that can be identified from the abnormal image. Input contents 602, 603, and 604 are examples of information that can be identified from a defective image, and either one of two types of contents is to be selected. The input content 602 is a screen for inputting a color mode, and either color or monochrome is to be selected. The input content 603 is a screen for selecting the type of a defect that is actually identified by the user. Whether “the defect in the image is a defect that does not exist in the original image data (streaks or the like occur)” or “the original image data is output with bad appearance due to decreased reproducibility” is selected. The input content 604 is a screen for inputting the type of original image data. Whether the image data only contains characters/lines or the image data contains a photograph/graphics is selected. As described above, a chart to be output and an analysis process to be executed are selected not based on direct technical terms (streak, unevenness, gradation, etc.) relating to the image quality problem but based on indirect words identified from the output abnormal image. This is a feature of the present exemplary embodiment.

The input contents are not limited to those described as examples in the present exemplary embodiment and may be any input content.

As described above, a chart that is suitable for the determination of the cause of the abnormal image is decided from a plurality of types of candidate charts according to a combination of a plurality of pieces of information input via an operation unit.

At this time, even if the user inputting information to the operation unit does not have technical knowledge about the image quality problem, the user can decide a chart by inputting information that can be identified.

Further, since a plurality of pieces of information is input, a chart that is suitable for the image diagnosis is more likely to be selected.

Next, in step S303, a chart is selected from charts/analysis processes 309 by use of the output result information 302 and an output result information correspondence table 304. More specifically, a chart to be output is selected using an observation result of an image determined by the user as including a defect and the output result information correspondence table 304.

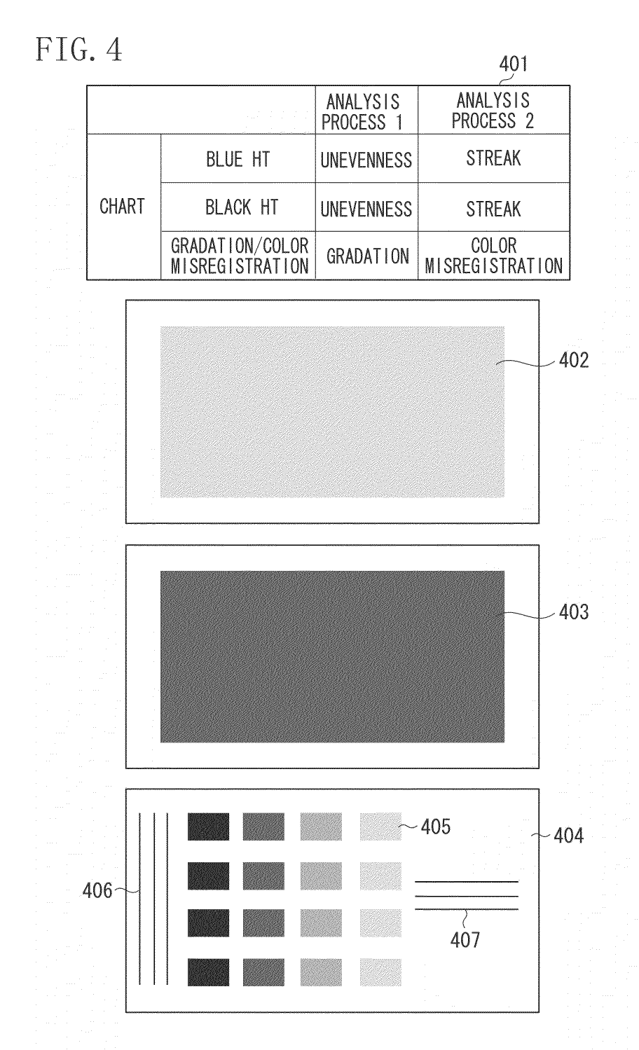

The following describes the charts/analysis processes 309 with reference to FIG. 4. A table 401 shows correspondences between the charts and the analysis processes. Charts 402, 403, and 404 are examples of charts used in the present exemplary embodiment.

The chart 402 is a blue halftone (hereinafter, HT) chart including halftone data of C and M. Similarly, the chart 403 is a K HT chart including halftone data of K.

In each of the charts, uniform data is arranged throughout the whole surface. Thus, it is possible to determine whether an output result contains an uneven portion and whether data such as streaks that is not contained in original image data to be output is added.

The chart 404 is a chart for the evaluation of gradations and color misregistration. Patches 405 include C, M, Y, and K and are gradually arranged from pale data to dark data. Through the patches 405, whether there is a gradation defect can be determined. Lines 406 and 407 are lines including four colors of CMYK. In a case where any of the color planes is misregistered, the misregistration can be detected.

The following describes the analysis processes according to the present exemplary embodiment. In the present exemplary embodiment, four types of analysis processes, namely, “unevenness,” “streak,” “gradation,” and “color misregistration” analysis processes are used.

In the “unevenness analysis,” a chart with a uniform plane such as the chart 402 or 403 is read, and in-plane uniformity is calculated. Then, the size and cycle of unevenness are calculated as feature amounts.

In the “streak analysis,” a chart with a uniform plane such as the chart 402 or 403 is read, and a specific direction such as a main scanning direction or a sub-scanning direction is checked to detect a line that satisfies a condition. Then, the width, length, and the like are calculated as feature amounts.

In the “gradation analysis,” luminance values of the patches 405 of the chart 404 are read, and luminance-density conversion is performed to calculate density values as feature amounts.

In the “color misregistration analysis,” the lines 406 and 407 of the chart 404 are read, and misregistration is calculated for each color plane of CMYK. Amounts of misregistration between the respective colors are calculated as feature amounts for each of the main and sub scanning directions.

As described above, there are cases where different analysis processes are executed although the same chart is used. Thus, to shorten the processing time, it is important to select not only a chart to be output but also an analysis process to be executed.

The types and contents of the charts and the analysis processes are not limited to those described as examples in the present exemplary embodiment, and any type and content can be used.

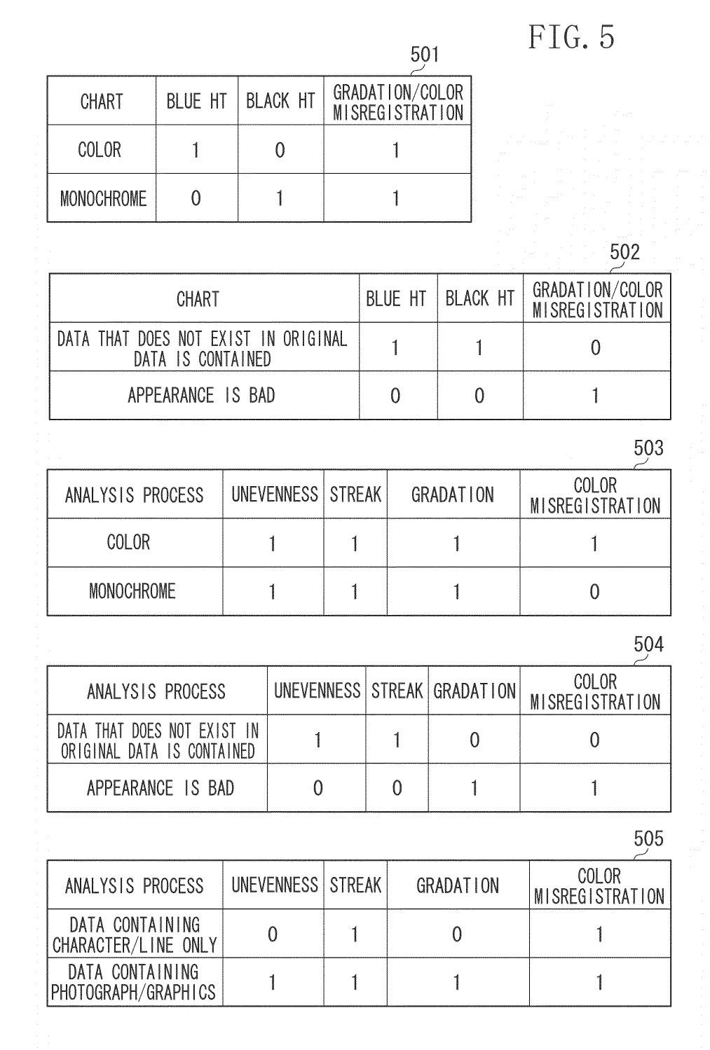

The following describes a specific example of a case where a chart is selected using the output result information 302 and the output result information correspondence table 304 in step S303, with reference to FIG. 5. Tables 501 and 502 are tables that associate a chart with output result information.

The table 501 corresponds to the input content 602 in FIG. 6. The table 501 indicates, when either one of “color” and “monochrome” is selected, whether each of the “blue HT,” “black HT,” and “gradation/color misregistration” charts corresponds to the selected color mode as a chart to be selected. In the table 501, “1” indicates that the chart corresponds to the selected color mode, whereas “0” indicates that the chart does not correspond to the selected color mode.

The table 502 corresponds to the input content 603 in FIG. 6. The table 502 indicates, when either one of “data that does not exist in original data is contained” and “appearance is bad” is selected, whether each of the “blue HT,” “black HT,” and “gradation/color misregistration” charts corresponds to the selected defect as a chart to be selected. As the foregoing describes, the output result information 302 indicates selection results of the input contents 602 to 604.

The following describes an example of a case where “monochrome” as the input content 602 and “data that does not exist in original data is contained” as the input content 603 are selected in step S303. Since “monochrome” is selected, there are two types of corresponding charts, namely, “black HT” and “gradation/color misregistration.” Further, since “data that does not exist in original data is contained” is selected, the corresponding chart is “black HT.” In this way, whether each of the charts corresponds to output result information is determined for each table, and a chart that is determined to “correspond” in all the tables is selected. In this example, “black HT” is determined to “correspond” in all the tables, so the “black HT” chart is selected. A plurality of charts may be selected depending on the input contents.

As described above, although there is a plurality of charts that can be used in the image diagnosis process, one or more charts are selectively decided in step S303, so that the image diagnosis process can be performed without using all the charts.

Next, in step S305, the selected chart is output with the printer to acquire an output chart 306.

Next, in step S307, an analysis process to be executed is selected from the charts/analysis processes 309, by use of the output result information 302 and the output result information correspondence table 304. More specifically, an analysis result is selected using a result identified by observing a print output result acquired in step S301 and the output result information correspondence table 304. The following describes such a method for selecting an analysis process, with reference to FIG. 5. Tables 503, 504, and 505 are tables that associate an analysis process with output result information.

The table 503 corresponds to the input content 602 in FIG. 6. The table 503 indicates, when “color” or “monochrome” is selected, whether each of the analysis processes, namely, the unevenness analysis, streak analysis, gradation analysis, and color misregistration analysis, corresponds to the selected color mode as an analysis process to be selected.

The table 504 corresponds to the input content 603 in FIG. 6. The table 504 indicates, when “data that does not exist in original data is contained” or “appearance is bad” is selected, whether each of the analysis processes, namely, “unevenness analysis,” “streak analysis,” “gradation analysis,” and “color misregistration analysis,” corresponds to the selected defect as an analysis process to be selected.

The table 505 corresponds to the input content 604 in FIG. 6. The table 505 indicates, when “data containing character/line only” or “data containing photograph/graphics” is selected, whether each of the analysis processes, namely, “unevenness analysis,” “streak analysis,” “gradation analysis,” and “color misregistration analysis,” corresponds to the selected data type as an analysis process to be selected.

In each of the tables 503 and 505, “1” indicates that the analysis process corresponds to output result information, whereas “0” indicates that the analysis process does not correspond to output result information.

The following describes an example of a case where “monochrome” as the input content 602, “data that does not exist in original data is contained” as the input content 603, and “data containing character/line only” as the input content 604 are selected in step S307. Since “monochrome” is selected, there are three types of corresponding analysis processes, namely, “unevenness,” “streak,” and “gradation.” Further, since “data that does not exist in original data is contained” is selected, there are two types of corresponding analysis processes, namely, “unevenness” and “streak.” Further, since “data containing character/line only” is selected, the corresponding analysis process is “streak.” In this way, whether each of the analysis processes corresponds to output result information is determined for each table, and an analysis process that is determined to “correspond” in all the tables is selected. In this example, “streak” is determined to “correspond” in all the tables, so the “streak” analysis is selected as an analysis process. A plurality of analysis processes may be selected depending on the input contents.

Next, in step S308, the output chart 306 is scanned by the scanner 119 to acquire a scan image 310.

Next, in step S311, the analysis process selected in step S307 is executed on the scan image 310, and an image feature amount 312 is output.

Next, in step S313, a process of determining an image quality problem that causes the abnormal image is performed using a threshold value 314 to determine the presence/absence and the type of an image quality problem.

Lastly, in step S315, an image quality problem determination result is displayed on the display device 118. An example is illustrated in FIG. 6. A screen 605 illustrates an example of the image quality problem determination result. In this example, a message as specific words is displayed so that the diagnosis result is understood by the user. In addition, coded information is also displayed so that a service or the like can be quantitatively determined. In a case where it is determined in step S313 that there is no image quality problem, information indicating that the image processing apparatus itself does not have a problem is displayed. In this way, details of the abnormal image can be identified from the specific and quantitative information. Thus, the burden of attending to the abnormal image can be reduced, and the attending time can be shortened.

While the present exemplary embodiment describes that a chart and an analysis process to be executed are selected using the correspondence table, any selection method may be used.

While the present exemplary embodiment describes that words are displayed on the UI to prompt the user to input details that can be identified from the abnormal image by the user, for example, sample images may be displayed to prompt the user to select a similar content. For example, cases in which streaks, unevenness, and the like occur are stored in advance as data, and the data may be read and displayed at the time of prompting the user to input information. The user selects a similar case from the displayed cases, so that a chart and an analysis process can be selected using the correspondence table as in the case of prompting the user to select words.

Further, while the present exemplary embodiment describes that the same input information is used to select a chart and an analysis process, input information for selecting a chart and input information for selecting an analysis process may be held separately.

Further, while the present exemplary embodiment describes that the MFP 101 performs an analysis process and an image quality problem determination process, an apparatus (not illustrated) such as a server connected to the MFP 101 may perform the processes.

In this case, determination results and information about the determination results may be sent to the MFP 101.

According to the present exemplary embodiment, a chart to be output and an analysis process to be executed are selected from information that can be identified by observing an output abnormal image. The selection of a chart leads to a reduction in the number of charts to be output, so that the costs can be reduced. Further, the selection of an analysis process can shorten the processing time. Furthermore, since an image quality problem can be determined based on information obtained from an abnormal image that is actually output, execution of image diagnosis becomes easier and the burden is reduced, as compared with the conventional techniques.

The following describes a second exemplary embodiment in which a scan setting is changed according to an analysis process.

In the first exemplary embodiment described above, the description has been given of the method including receiving an input obtained from an output abnormal image, selecting a chart to be output and an analysis process to be executed, and performing image diagnosis.

In some cases, however, a suitable scan setting differs depending on an analysis process to be executed. For example, in a case where the analysis process is “streak” analysis, since thin lines on a chart need to be read, it is desirable to scan the chart with the highest possible resolution for the scanner. On the other hand, in a case where the analysis process is “gradation” analysis, an average value of signal values of patches on a chart is acquired, so considering the calculation time, it is acceptable to scan a chart with a low resolution.

In response to the foregoing situation, the present exemplary embodiment will describe an example in which a scan setting suitable for an analysis process is taken into consideration.

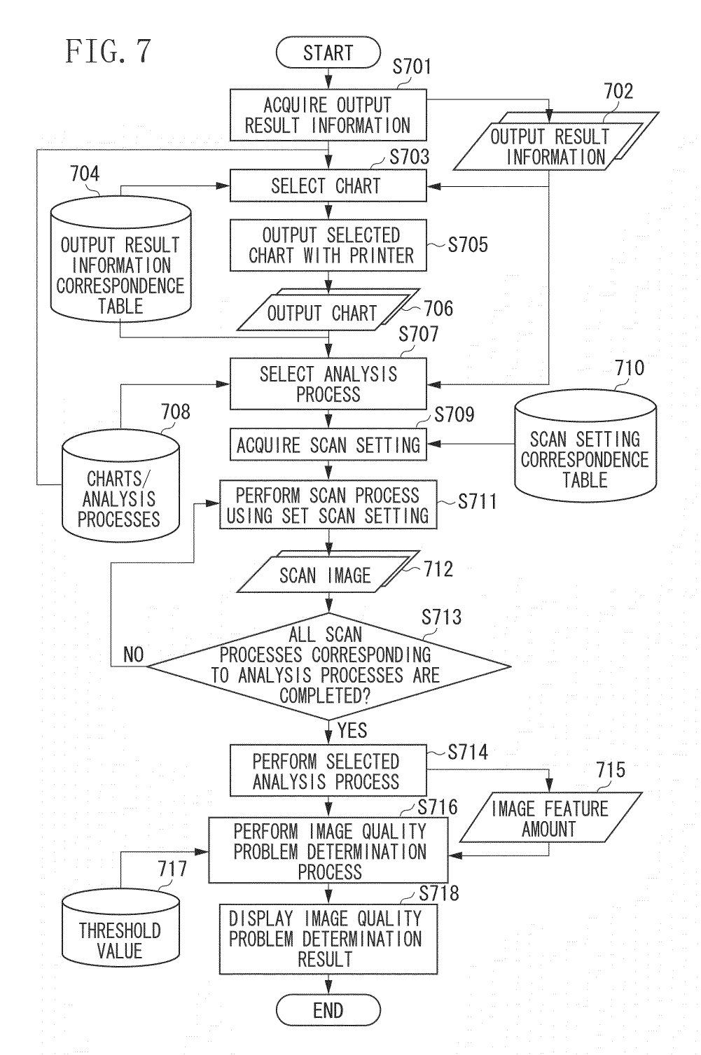

The following describes an image diagnosis process according to the present exemplary embodiment with reference to FIG. 7. The image diagnosis process is controlled by the image diagnosis unit 126. In the process flow described below, processes in steps S701 to S718 are executed and realized by the CPU 103 included in the controller 102, and acquired data is stored in the storage device 121. Further, the display device 118 displays an instruction to the user on the UI, and an instruction from the user is received from the input device 120.

The processes in steps S701 to S707 are similar to those in steps S301 to S307 in FIG. 3, so description of steps S701 to S707 is omitted.

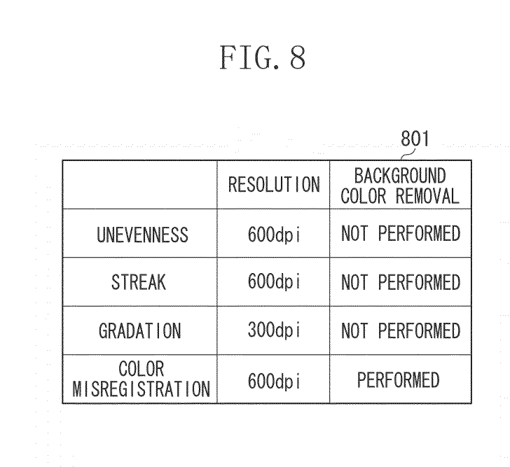

In step S709, a scan setting is acquired using a scan setting correspondence table 710. An example of the scan setting correspondence table 710 is illustrated in FIG. 8.

A correspondence table 801 is a table showing a correspondence relationship between analysis processes and scan settings. The analysis processes are the same as the analysis processes to be selected in step S707.

The scan settings are settings used when image data (chart) is read with the scanner. In the present exemplary embodiment, the scan settings include two types of scan settings, “resolution” and “background color removal.” While the present exemplary embodiment uses two types of scan settings, the types and the number of types of scan settings may be any type and any number.

The “resolution” is a reading resolution set for scanning using the scanner 119. In a case of a scanner with 600 dpi, selectable resolutions are assumed to be two resolutions, 600 dpi and 300 dpi.

The “background color removal” is a function of correcting a background of a document to white. For example, in a case where the analysis process is “registration analysis,” a background of a document is desirably white so that no influence is given by the background. On the other hand, in a case where the analysis process is “gradation analysis,” it is desirable not to perform the background color removal because highlight data may be changed.

For example, in a case where the analysis process selected in step S707 is “streak,” when the correspondence table 801 of the scan setting correspondence table 710 is referred to in step S709, it is determined that the “resolution” is “600 dpi” and the “background color removal” is “not performed.” In a case where a plurality of analysis processes is selected in step S707, a plurality of corresponding scan settings is acquired.

Next, in step S711, a scan process is performed on the chart by use of the set scan setting to acquire a scan image 712. In a case where a plurality of scan settings is acquired in step S709, the scan process is performed a plurality of times.

Next, in step S713, it is determined whether all scan processes corresponding to the analysis processes are completed. If it is determined that all scan processes are not completed (NO in step S713), the process in step S711 is repeated. At this time, since the same chart may be used in different analysis processes in some cases, the same chart may be read a plurality of times using different scan settings.

The processes in steps S714 to S718 are similar to those in steps S311 to S315 in FIG. 3, so description of steps S714 to S718 is omitted.

While the present exemplary embodiment describes that the scan settings are acquired using the correspondence table, any method for acquiring scan settings may be used.

According to the present exemplary embodiment, a chart to be output and an analysis process to be executed are selected from information that can be identified by observing an output abnormal image. The selection of a chart leads to a reduction in the number of charts to be output, so that the costs can be reduced. Further, the selection of an analysis process can shorten the processing time. Furthermore, since an image quality problem can be determined based on an abnormal image that is actually output, execution of image diagnosis becomes easier and the burden is reduced, as compared with the conventional techniques.

Further, according to the present exemplary embodiment, a scan setting is changed according to an analysis process to be executed, so that the accuracy of the analysis process can be increased and the processing time can be shortened.

The following describes a third exemplary embodiment in which after an analysis process is performed, it is determined whether an image quality problem can be solved by a correction function included in the image processing apparatus.

The above exemplary embodiments describe the methods including receiving an input based on information that can be identified by observing an output abnormal image, selecting a chart to be output and an analysis process to be executed, and performing image diagnosis.

However, the abnormalities detected as a result of image diagnosis include an abnormality that can be corrected without a serviceman by execution of a correction function included in the image processing apparatus. In this case, the abnormality can be originally solved without a serviceman, and the period of time until the user calls in a serviceman becomes downtime to decrease the productivity of the user.

In view of the foregoing situation, the present exemplary embodiment will describe an example in which a correction function included in the image processing apparatus is executed according to an analysis process.

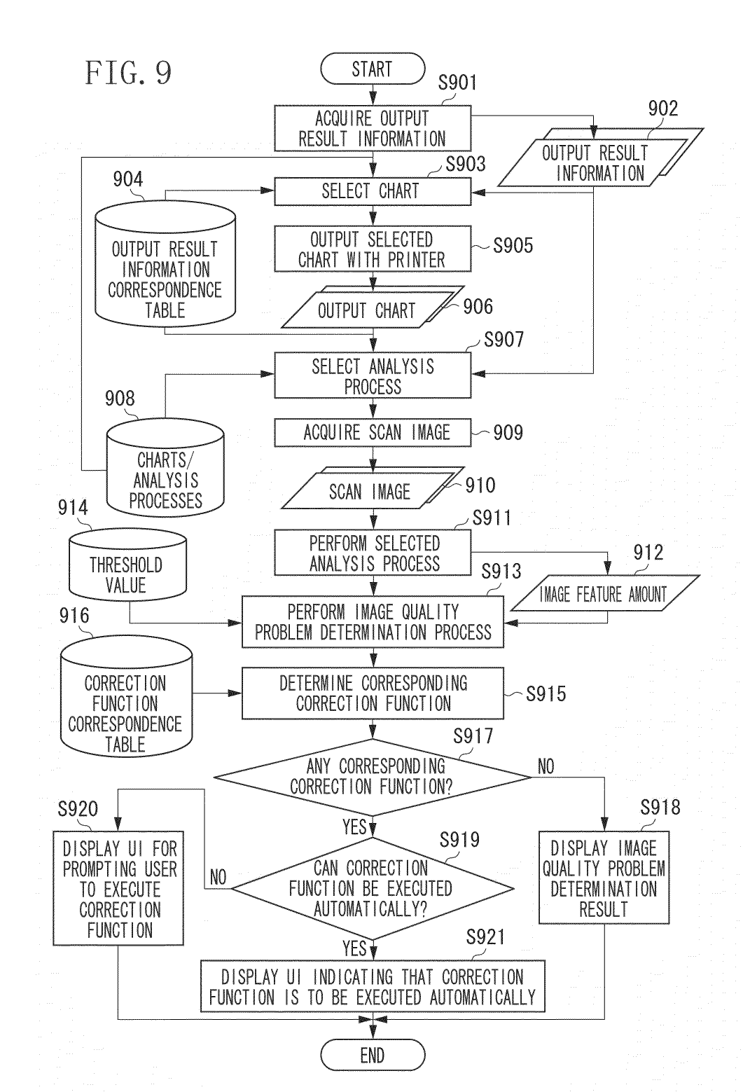

The following describes an image diagnosis process according to the present exemplary embodiment with reference to FIG. 9. The image diagnosis process is controlled by the image diagnosis unit 126. In the process flow described below, the processes in steps S901 to S921 are executed and realized by the CPU 103 included in the controller 102, and acquired data is stored in the storage device 121. Further, the display device 118 displays an instruction to the user on the UI, and an instruction from the user is received from the input device 120.

The processes in steps S901 to S913 are similar to those in steps S301 to S313 in FIG. 3, so description of steps S901 to S913 is omitted.

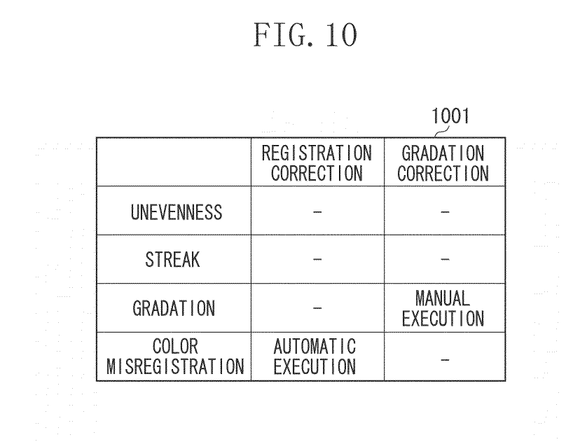

In step S915, it is determined whether there is any corresponding correction function, using a correction function correspondence table 916. An example of the correction function correspondence table 916 is illustrated in FIG. 10.

A correspondence table 1001 is a table showing a correspondence relationship between analysis processes and correction functions. The analysis processes are the same as the analysis processes to be selected in step S907.

A correction function is a function of performing a process for solving a defect that causes an abnormal image when the abnormal image occurs. In the present exemplary embodiment, the correction function includes two types of correction functions, “registration correction” and “gradation correction.” While the present exemplary embodiment uses two types of correction functions, the types and the number of types of correction functions may be any type and any number.

The “registration correction” is a function of measuring a position of an output image for each of the CMYK colors by use of an internal sensor (not illustrated) of the printer 115 to determine whether an image is output in a predetermined position, and in a case where misregistration occurs, correcting the misregistration. If an execution instruction is given once, the process is automatically completed without the user performing an operation. In the correspondence table 1001, “automatic execution” indicates that the registration correction function can handle an analysis process, whereas “-” indicates that the registration correction function cannot handle an analysis process. Although the “registration correction” is “manually” executable by use of a scanner or the like, the “registration correction” is to be executed “automatically” in the present exemplary embodiment.

The “gradation correction” is a function of printing gradation data (chart) with the printer 115, reading the chart with the scanner 119, performing luminance-density conversion to convert luminance to a density value, and correcting the density value if the converted density value is deviated from a predetermined density value. The user gives an execution instruction, and a chart is output. Thereafter, the user has to set the output chart sheet in the scanner 119. Thus, execution of the “gradation correction” requires a manual operation. In the correspondence table 1001, “manual execution” indicates that the gradation correction can handle an analysis process, whereas “-” indicates that the gradation correction cannot handle an analysis process. Although the “gradation correction” can be executed “automatically” by use of a dedicated sensor or the like (e.g., a sensor between a discharge port and a fixing unit on a conveyance path) located within the apparatus, the “gradation correction” is to be executed “manually” in the present exemplary embodiment.

The correction functions are not limited to those described as examples in the present exemplary embodiment and may be any correction function.

For example, in step S915, if the analysis process is “color misregistration,” the “registration correction” is “automatic execution” and the “gradation correction” is “-” according to the correspondence table 1001. Thus, it is determined that the “registration correction” is a function that can correct the abnormality and the “registration correction” is “automatically executable.” A plurality of correction functions may be executable depending on the contents of the correspondence table.

Next, in step S917, it is determined whether there is any corresponding correction function. If there is no corresponding correction function (NO in step S917), then in step S918, an image quality problem determination result is displayed. The process in step S917 is similar to step S315 in FIG. 3.

On the other hand, in step S917, if it is determined that there is a corresponding correction function (YES in step S917), then in step S919, it is determined whether the correction function can be executed automatically, based on the contents of the correspondence table 1001.

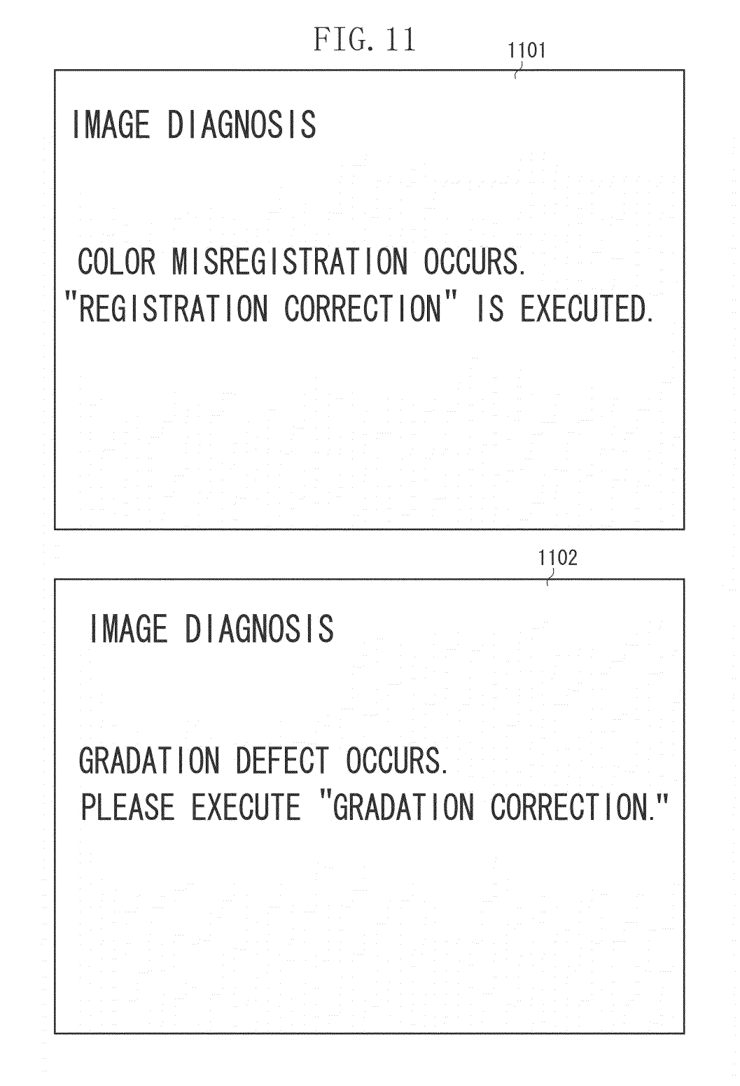

In step S919, if it is determined that the correction function cannot be executed automatically (NO in step S919), then in step S920, a UI for prompting the user to execute the correction function is displayed. An example of the UI is illustrated in FIG. 11. A UI 1102 is an example of the UI that is displayed in a case where the correction function cannot be executed automatically. Since the “gradation correction” is a function that cannot be executed automatically, the UI that prompts the user to execute the correction function is displayed.

On the other hand, in step S919, if it is determined that the correction function can be executed automatically (Yes in step S919), then in step S921, a UI indicating that the correction function is to be executed automatically is displayed. An example is illustrated in FIG. 11. A UI 1101 is an example of the UI that is displayed in a case where the correction function can be executed automatically. Since the “registration correction” is a function that can be executed automatically, the UI indicating that the correction function is to be executed is displayed. In the case of automatic execution, it is not necessary to display a UI indicating a specific process content.

While the present exemplary embodiment describes that a correction function corresponding to an analysis process is determined using the correspondence table, the determination method may be any determination method.

Further, while the present exemplary embodiment describes that the correspondence table showing the correspondences between the analysis processes and the correction functions is referred to, the correction functions do not have to be associated with the analysis processes. For example, the correction functions may be associated with image quality determination results.

According to the present exemplary embodiment, a chart to be output and an analysis process to be executed are selected from information that can be identified by observing an output abnormal image. The selection of a chart reduces the number of charts to be output, so that the costs can be reduced. Further, the selection of an analysis process can shorten the processing time. Furthermore, since an image quality problem can be determined based on information obtained from an abnormal image that is actually output, execution of image diagnosis becomes easier and the burden is reduced, as compared with the conventional techniques.

Furthermore, according to the present exemplary embodiment, whether there is a correction function is determined according to an analysis process to be executed, and if there is a correction function, the abnormal image can be corrected either automatically or manually. Thus, in a case where an image quality problem causing an abnormal image can be solved without a serviceman, downtime can be further shortened to prevent a decrease in the productivity of the user.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-100843, filed May 14, 2014, which is hereby incorporated by reference herein in its entirety.

What is claimed is:

1. An image processing apparatus comprising:
an image forming unit configured to form an image;
an input unit configured to input, in response to detecting an abnormality in the formed image, a plurality of pieces of information about a feature of the formed image via an operation unit; and
a chart forming unit configured to form, by the image forming unit, a chart for determining an abnormality in an image, wherein the chart is decided according to a combination of the plurality of pieces of information input by the input unit via the operation unit.

2. The image processing apparatus according to claim 1, further comprising a determining unit configured to output a chart formed by the chart forming unit, and determine an abnormality in an image formed by the image forming unit, by using the output chart.

3. The image processing apparatus according to claim 1, further comprising a decision unit configured to decide an analysis process according to a combination of the plurality of pieces of information input by the input unit,
wherein the analysis process decided by the decision unit is executed on a chart formed by the chart forming unit.

4. The image processing apparatus according to claim 1, wherein a chart output from the chart forming unit is a chart selectively decided from a plurality of types of charts.

5. The image processing apparatus according to claim 3, wherein an analysis process decided by the decision unit is an analysis process selectively decided from a plurality of types of analysis processes.

6. The image processing apparatus according to claim 2, wherein the determining unit determines an abnormality in an image formed by the image forming unit, by using a feature amount acquired from a reading result of a chart output from the chart forming unit.

7. The image processing apparatus according to claim 2, further comprising a unit configured to determine whether a correction process for correcting an abnormality in an image that is determined by the determining unit is executable,
wherein in a case where it is determined that the correction process is executable, the correction process for correcting the abnormality of the image that is determined by the determining unit is executed.

8. The image processing apparatus according to claim 7, wherein in a case where the correction process is executable, a user is prompted to execute a correction function.

9. A method for controlling an image processing apparatus including an image forming unit configured to form an image, the method comprising:
inputting, in response to detecting an abnormality in the formed image, a plurality of pieces of information about a feature of the formed image via an operation unit; and
forming, by the image forming unit, a chart for determining an abnormality in an image, wherein the chart is decided according to a combination of the plurality of pieces of information input by the inputting via the operation unit.

10. A non-transitory computer readable storage medium storing a program for causing a computer to perform the method according to claim 9.
